(19) United States
(12) Patent Application Publication
(10) Pub. No.: US 2026/0209633 A1
(43) Pub. Date: Jul. 23, 2026

(54) COMPOSITION COMPRISING SOPHOROLIPIDS AND RHAMNOLIPIDS AND/OR GLUCOLIPIDS

(71) Applicant: Evonik Operations GmbH, Essen (DE)

(72) Inventors: Alexandra Trambitas, Alzenau (DE); Konrad Grygiel, Dortmund (DE); Silvia Jentsch, Bad Soden-Salmuenster (DE); Stefan Julian Liebig, Duesseldorf (DE); Nadine Truchan, Duesseldorf (DE)

(73) Assignee: Evonik Operations GmbH, Essen (DE)

(21) Appl. No.: 19/137,464

(22) PCT Filed: Dec. 5, 2023
(86) PCT No.: PCT/EP2023/084246

§ 371 Date: Jun. 10, 2025

(30) Foreign Application Priority Data
Dec. 15, 2022 (EP) 22213761.4

(51) Int. Cl. C11D 1/66

(52) U.S. Cl. CPC C11D 1/662; C11D 2111/14; C11D 2111/42; C11D 2111/44

(57) ABSTRACT

A composition contains sophorolipids and rhamnolipids and/or glucolipids at certain ratios and the composition is used in cleaning surfaces.

### FIELD OF THE INVENTION

The invention relates to a composition comprising sophorolipids and rhamnolipids and/or glucolipids at certain ratios. The invention also relates to different uses, for example the use of the composition for cleaning, especially for cleaning of hard surfaces.

### PRIOR ART

The removal of fatty stains, especially from hard surfaces like dishes and cutlery, still is difficult to achieve with detergents, the main surfactants of which are based on renewables, like for example sophorolipids.

In the state of the art, high amounts of other surfactants, which are not bio based, are included in the compositions to achieve a satisfactory cleansing.

EP1445302 discloses detergent compositions comprising at least one glycolipid biosurfactant and at least one non-glycolipid surfactant, characterized in that the at least one glycolipid biosurfactant and the at least one non-glycolipid surfactant are in the micellar phase.

It is an object of the invention to provide a composition with high cleaning capabilities, especially in cleaning of hard surfaces, preferably for cleaning of fatty stains.

### DESCRIPTION OF THE INVENTION

It was found that, surprisingly, that compositions, the main surfactant of which are sophorolipids, in combination with a smaller amount of rhamnolipids and/or glucolipids solve the problem of the instant invention.

The present invention therefore provides a composition comprising
A) at least one sophorolipid and
B) at least one selected from rhamnolipids and glucolipids,
as described in more detail in claim 1.

The invention further provides a method of cleaning articles as described in more detail in claim 8.

An advantage of the present invention is that the formulations foam strongly, i.e. generate large foam volumes.

A further advantage of the present invention is that the formulations generate foams stable over time.

A further advantage of the present invention is that the formulations have good initial foaming behaviour.

A further advantage of the present invention is that the formulations have good skin compatibility.

A further advantage of the present invention is that the formulations have good run-off behaviour.

A further advantage of the present invention is that the formulations have good drying behaviour.

A further advantage of the present invention is that the formulations also show an excellent foam-forming capacity in the presence of oil soiling.

Another advantage of the present invention is that strongly foaming formulations may be formulated, without the use of surfactants, which have been prepared with ethylene oxide.

A further advantage is the reduced necessity for microbial active preservatives.

A further advantage of the composition according to the invention is its low viscosity and therefore simple processability in any desired aqueous surface-active system.

A further advantage of the compositions according to the invention is their good skin and hair cleansing properties.

A further advantage of the compositions according to the invention is their good make-up removal property.

A further advantage of the compositions according to the invention is their good lipstick removal property.

A further advantage of the compositions according to the invention is their good eye make-up removal property.

A further advantage of the compositions according to the invention is their very good solubilizing efficacy for essential oils at low usage levels.

A further advantage of the composition according to the invention is their mildness and good physiological compatibility.

A further advantage of the compositions according to the invention is their good skin feel during and after washing.

A further advantage of the compositions according to the invention is their good rinseability compared to other surface-active compositions.

A further advantage of the compositions according to the invention is that they leave a smooth and soft skin feel after washing.

A further advantage of the mixture compositions according to the invention is that they can be synthesized free from petrochemical-based raw materials.

A further advantage of the mixture compositions according to the invention is that they can be synthesized free from critical raw materials such as tropical oils.

A further advantage of the mixture compositions according to the invention is their outstanding microbiological stability.

A further advantage of the mixture compositions according to the invention is that properties such as combability, softness, shapeability, shine, manageability and disentanglability of hair can be improved with the use according to the invention.

Yet another advantage of the mixture compositions according to the invention is that a particularly good foam creaminess can be achieved with the use according to the invention.

A further advantage of the mixture compositions according to the invention is that it reduces the combing forces on wet and dry hair.

Another advantage of the mixture compositions according to the invention that it may function as moisturizer (humectant) in cosmetic formulations.

One advantage of the present invention is that the compositions of the instant invention have a very good cleaning performance, especially in fatty stain removal from fabrics.

Another advantage of the present invention is that the compositions of the instant invention can be rinsed off from a surface, preferably from fibres, that had been cleaned, very easily.

A further advantage is that the compositions of the instant invention support enzyme stability in terms of storage.

One advantage of the present invention is that a pure biological detergent is provided with all ingredients being of biological origin by the composition of the instant invention.

Another advantage of the present invention is that the formula shows especially good emulsification and dispersing properties.

Another advantage of the present invention is that detergents using mild surfactants with low aqua toxicity are provided by the composition of the instant invention.

Another advantage of the present invention is that the compositions of the instant invention can be formulated as 100% biodegradable.

Another advantage is that the formulation shows excellent compatibility, with all materials that comes into contact with, with respect to stress corrosion.

Another advantage is that the formulation can be diluted very easily with water without the necessity of excessive stirring.

One advantage of the present invention is that the compositions according to the instant invention have a positive odour profile.

Another advantage of the present invention is that the compositions according to the instant invention have an improved colour stability. Colour change reactions could come from Maillard reaction, which is a chemical reaction between proteins or amino acids and sugars. Both reaction partners, proteins and sugars, are typically contained in small amounts in a fermentative produced biosurfactant like Rhamnolipids, Sophorolipids or Rubiwettin. These small concentrations are sufficient to have a colour change from light to dark.

A further advantage is that the compositions according to the instant invention have improved cleaning properties of surfaces, especially fatty stains Another advantage is that the compositions according to the instant invention has excellent foaming properties.

A further advantage is that the compositions according to the instant invention is their reduced irritation for human skin.

Another advantage is that the compositions according to the instant invention is their mildness and good physiological compatibility, in particular characterized by a high value in the red blood cell (RBC) test.

A further advantage is that the compositions according to the instant invention is their good skin feel during and after washing.

Another advantage is that the compositions according to the instant invention is that they leave behind a smooth and soft skin feel after washing.

Another advantage is that the compositions according to the instant invention is their outstanding microbial stability.

Another advantage is that the compositions according to the instant invention have an improved ability to dissolve oils and fats.

Another advantage is that the compositions according to the instant invention is easier removed from the surface and consequently needs less water for the rinsing step

Another advantage is that the compositions according to the instant invention is that you can develop formulations baby friendly

Another advantage is that the compositions according to the instant invention gives the benefit of having a streakless cleaning when used to clean glass, mirrors, windshields and other sensitive surfaces.

Another advantage is that the compositions according to the instant invention can clean effectively even at lower temperatures

The instant invention thus provides a composition comprising
A) at least one sophorolipid and
B) at least one selected from rhamnolipids and glucolipids,
characterized in that the weight ratio of all sophorolipids to all rhamnolipids and glucolipids comprised in the composition is in the range of from 2:1 to 500:1, preferably from 3:1 to 200:1, more preferably from 5:1 to 100:1, most preferable from 10:1 to 50:1, especially 20:1 to 40:1.

Within the context of the present invention, “biosurfactants” are understood as meaning all glycolipids produced by fermentation. The term “biosurfactant” also covers glycolipids that are chemically or enzymatically modified after fermentation, as long as structurally a glycolipid remains. Raw materials for producing the biosurfactants that can be used are carbohydrates, in particular sugars such as e.g. glucose and/or lipophilic carbon sources such as fats, oils, partial glycerides, fatty acids, fatty alcohols, long-chain saturated or unsaturated hydrocarbons.

In the context of the present invention, the terms “surfactant” is understood to mean organic substances having interface-active properties that have the ability to reduce the surface tension of water at 20° C. and at a concentration of 0.5% by weight based on the overall composition to below 45 mN/m. Surface tension is determined by the DuNoüy ring method at 20° C.

Where average values are stated hereinbelow, then, unless stated otherwise, these are number-averaged average values.

Unless stated otherwise, percentages are data in percent by weight.

Wherever measurement values are stated hereinbelow, then, unless stated otherwise, these have been determined at a temperature of 25° C. and a pressure of 1013 mbar.

In the context of the present invention, the term “sophorolipids” preferably is understood as meaning compounds of the general formulae (Ia) and (Ib) and salts thereof

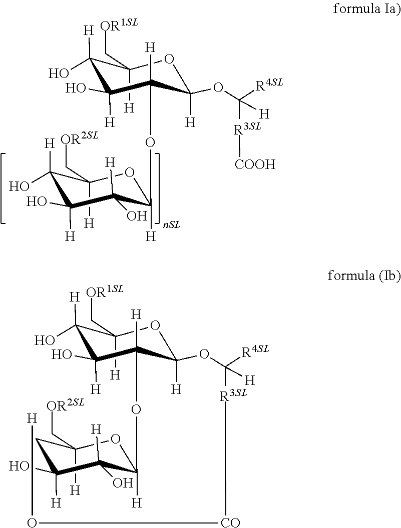

where
R^{1SL}=H or CO—CH₃,
R^{2SL}=H or CO—CH₃,
R^{3SL}=a divalent organic moiety which comprises 6 to 32 carbon atoms and which is unsubstituted or substituted by hydroxyl functions, is unbranched and optionally comprises one to three double or triple bonds,
R^{4SL}=H, CH₃ or a monovalent organic radical which comprises 2 to 10 carbon atoms and which is unsubstituted or substituted by hydroxyl functions, which is unbranched and which optionally comprises one to three double or triple bonds, and
nSL=1 or 0.
Sophorolipids may be used in accordance with the invention in their acid form or their lactone form. Preferred compositions according to the instant invention comprise a sophorolipid in which the ratio by weight of lactone form to acid form is in the range of 20:80 to 80:20, especially preferably in the ranges of 30:70 to 40:60.

To determine the content of sophorolipids in the acid or lactone form in a formulation, refer to EP14111111B1, page 8, paragraph [0053].

Preferably, the composition according to the instant invention is characterized in that component B) is selected from rhamnolipids., in particular mono-, di- and polyrhamnolipids, preferably mono- and di-rhamnolipids.

The term “rhamnolipids” in the context of the present invention preferably is understood to mean particularly compounds of the general formula (II) and salts thereof,

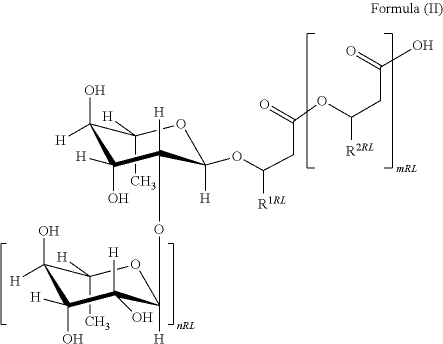

where
mRL=2, 1 or 0,
nRL=1 or 0,
R^{1RL} and R^{2RL}=mutually independently, identical or different, organic residues having 2 to 24, preferably 5 to 13 carbon atoms, in particular optionally branched, optionally substituted, particularly hydroxy-substituted, optionally unsaturated, in particular optionally mono-, bi- or tri-unsaturated alkyl residues, preferably those selected from the group consisting of pentenyl, heptenyl, nonenyl, undecenyl and tridecenyl and (CH₂)ₒ—CH₃ where o=1 to 23, preferably 4 to 12. If nRL=1, the glycosidic bond between the two rhamnose units is preferably in the α-configuration. The optically active carbon atoms of the fatty acids are preferably present as R-enantiomers (e.g. (R)-3-{(R)-3-[2-O-(α-L-rhamnopyranosyl)-α-L-rhamnopyranosyl]oxydecanoyl}oxydecanoate).

The term “di-rhamnolipid” in the context of the present invention is understood to mean compounds of the general formula (II) or salts thereof, where nRL=1.

The term “mono-rhamnolipid” in the context of the present invention is understood to mean compounds of the general formula (II) or salts thereof, where nRL=0.

Distinct rhamnolipids are abbreviated according to the following nomenclature: “diRL-CXCY” are understood to mean di-rhamnolipids of the general formula (II), in which one of the residues R^{1RL} and R^{2RL}=(CH₂)ₒ—CH₃ where o=X-4 and the remaining residue R¹ or R²=(CH₂)ₒ—CH₃ where o=Y-4.

“monoRL-CXCY” are understood to mean mono-rhamnolipids of the general formula (II), in which one of the residues R^{1RL} and R^{2RL}=(CH₂)ₒ—CH₃ where o=X-4 and the remaining residue R^{1RL} or R^{2RL}=(CH₂)ₒ—CH₃ where o=Y-4.

The nomenclature used therefore does not distinguish between “CXCY” and “CYCX”.

For rhamnolipids where mRL=0, monoRL-CX or diRL-CX is used accordingly.

If one of the abovementioned indices X and/or Y is provided with “:Z”, this signifies that the respective residue R^{1RL} and/or R^{2RL} is equal to an unbranched, unsubstituted hydrocarbon residue having X-3 or Y-3 carbon atoms having Z double bonds.

Methods for preparing the relevant rhamnolipids are disclosed, for example, in EP2786743 and EP2787065.

Rhamnolipids applicable in the context of the instant invention can also be produced by fermentation of Pseudomonas, especially Pseudomonas aeruginosa, which are preferably non genetically modified cells, a technology already disclosed in the eighties, as documented e.g. in EP0282942 and DE4127908. Rhamnolipids produced in Pseudomonas aeruginosa cells which have been improved for higher rhamnolipid titres by genetical modification can also be used in the context of the instant invention; such cells have for example been disclosed by Lei et al. in Biotechnol Lett. 2020 June; 42(6):997-1002.

Rhamnolipids produced by Pseudomonas aeruginosa are commercially available from Jeneil Biotech Inc., e.g. under the tradename Zonix, from Logos Technologies (technology acquired by Stepan), e.g. under the tradename NatSurFact, from Biotensidion GmbH, e.g. under the tradename Rhapynal, from AGAE technologies, e.g. under the name R⁹⁰, R⁹⁵, R⁹⁵Md, R⁹⁵Dd, from Locus Bio-Energy Solutions and from Shanghai Yusheng Industry Co. Ltd., e.g. under the tradename Bio-201 Glycolipids.

The present invention provides a composition preferably comprising as component B) rhamnolipids, characterized in that component B) comprises 51% by weight to 100% by weight, preferably 60% by weight to 95% by weight, particularly preferably 80% by weight to 90% by weight, of mono-rhamnolipids, especially those of formula (II) with nRL=0, where the percentages by weight refer to the sum of all of the rhamnolipids present.

The present invention further provides a composition preferably comprising as component B) rhamnolipids, characterized in that component B) comprises
51% by weight to 95% by weight, preferably 55% by weight to 80% by weight, particularly preferably 60% by weight to 70% by weight, of diRL-C10C10,
where the percentages by weight refer to the sum of all of the rhamnolipids present.

A preferred composition according to the invention is characterized in that the composition comprises as component B) rhamnolipids as described above with a content of
0.5% by weight to 15% by weight, preferably 3% by weight to 12% by weight, particularly preferably 5% by weight to 10% by weight, of diRL-C10C12:1,
where the percentages by weight refer to the sum of all of the rhamnolipids present.

A further preferred composition according to the invention is characterized in that the composition comprises as component B) rhamnolipids as described above with a content of 0.5 to 25% by weight, preferably 3% by weight to 15% by weight, particularly preferably 5% by weight to 12% by weight, of diRL-C10C12,
where the percentages by weight refer to the sum of all of the rhamnolipids present.

A further preferred composition according to the invention is characterized in that the composition comprises as component B) rhamnolipids as described above with a content of 0.1% by weight to 25% by weight, preferably 2% by weight to 10% by weight, particularly preferably 4% by weight to 8% by weight, of diRL-C8C10,
where the percentages by weight refer to the sum total of all rhamnolipids present.

An even further preferred composition according to the invention is characterized in that the composition comprises as component B) rhamnolipids as described above with a content of
0.1% by weight to 5% by weight, preferably 0.5% by weight to 3% by weight, particularly preferably
0.5% by weight to 2% by weight, of monoRL-C8C10 and/or, preferably and
0.1% by weight to 5% by weight, preferably 0.5% by weight to 3% by weight, particularly preferably
0.5% by weight to 2% by weight, of monoRL-C10C10,
where the percentages by weight refer to the sum of all of the rhamnolipids present.

The present invention provides a composition alternatively preferably comprising as component B) rhamnolipids, characterized in that component B) comprises
51% by weight to 100% by weight, preferably 60% by weight to 95% by weight, particularly preferably 80% by weight to 90% by weight, of mono-rhamnolipids, especially those of formula (II) with nRL=0,
where the percentages by weight refer to the sum of all of the rhamnolipids present.

The present invention provides a composition alternatively preferably comprising as component B) rhamnolipids, characterized in that component B) comprises
10% by weight to 50% by weight, preferably 20% by weight to 40% by weight, particularly preferably 25% by weight to 35% by weight, of monoRL-C10C10 and
where the percentages by weight refer to the sum of all of the rhamnolipids present.

The alternatively preferred composition according to the invention is preferably characterized in that the composition comprises as component B) rhamnolipids as described above with a content of 10% by weight to 30% by weight, preferably 12% by weight to 25% by weight, particularly preferably 15% by weight to 20% by weight, of diRL-C10C10,
where the percentages by weight refer to the sum of all of the rhamnolipids present.

The alternatively preferred composition according to the invention is characterized in that the composition comprises as component B) rhamnolipids as described above with a content of 10% by weight to 30% by weight, preferably 12% by weight to 25% by weight, particularly preferably 15% by weight to 20% by weight, of monoRL-C8C10,
where the percentages by weight refer to the sum of all of the rhamnolipids present.

The alternatively preferred composition according to the invention is characterized in that the composition comprises as component B) rhamnolipids as described above with a content of 3% by weight to 25% by weight, preferably 5% by weight to 20% by weight, particularly preferably 10% by weight to 15% by weight, of monoRL-C10C12:1,
where the percentages by weight refer to the sum total of all rhamnolipids present.

The alternatively preferred composition according to the invention is characterized in that the composition comprises as component B) rhamnolipids as described above with a content of 1% by weight to 15% by weight, preferably 2% by weight to 10% by weight, particularly preferably 3% by weight to 8% by weight, of diRL-C10C12,
where the percentages by weight refer to the sum of all of the rhamnolipids present.

In connection with the present invention, the term “glucolipids” preferably is understood as meaning compounds of the general formula (III) and salts thereof,

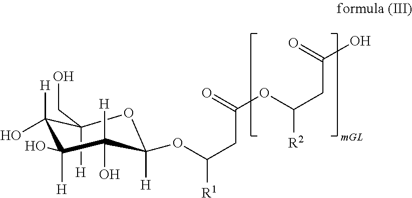

where
mGL=1 or 0,
R^{1GL} and R^{2GL}=independently of one another identical or different organic radical having 2 to 24 carbon atoms, in particular optionally branched, optionally substituted, in particular hydroxy-substituted, optionally unsaturated, in particular optionally mono-, di- or triunsaturated, alkyl radical, preferably one selected from the group consisting of pentenyl, heptenyl, nonenyl, undecenyl and tridecenyl and (CH₂)ₒ—CH₃ where o=1 to 23, preferably 4 to 12.

Distinct glucolipids are abbreviated according to the following nomenclature: “GL-CXCY” is understood as meaning glucolipids of the general formula (III) in which one of the radicals R^{1GL} and R^{2GL}=(CH₂)ₒ—CH₃ where o=X-4 and the remaining radical R^{1GL} or R^{2GL}=(CH₂)ₒ—CH₃ where o=Y-4.

The nomenclature used thus does not differentiate between “CXCY” and “CYCX”.

If one of the aforementioned indices X and/or Y is provided with “:Z”, then this means that the respective radical R^{1GL} and/or R^{2GL}=an unbranched, unsubstituted hydrocarbon radical with X-3 or Y-3 carbon atoms having Z double bonds.

Methods for production of glucolipids can be carried out as described in WO2019154970.

Compositions according to the invention comprise component A) preferably at a concentration of from 0.5% by weight to 40% by weight, preferably from 1% by weight to 30% by weight, particularly preferably from 2% by weight to 20% by weight, the percentages by weight referring to the total composition.

Compositions according to the invention comprise component B) preferably at a concentration of from 0.25% by weight to 20% by weight, preferably from 0.5% by weight to 15% by weight particularly preferably from 1% by weight to 1% by weight, the percentages by weight referring to the total composition.

Compositions according to the invention comprise component A) and component B) in total preferably at a concentration of 0.8% by weight to 45% by weight, preferably 1.4% by weight to 30% by weight, and particularly preferably from 3.0% by weight to 20% by weight, wherein the percentages by weight refer to the total composition.

A preferred composition according to the invention is characterized in that the pH of the composition at 25° C. is from 2.0 to 12.0, preferably 3.0 to 11.0, more preferably 4.0 to 9.0, in particular 5.0 to 8.0 and especially preferably 5.6 to 7.4.

The “pH” in connection with the present invention—unless stated otherwise—is defined as the value which is measured for the relevant composition at 25° C. after stirring for five minutes using a pH electrode calibrated in accordance with ISO 4316 (1977).

A preferred composition according to the instant invention is characterized in that it comprises at least one surfactant, preferably selected from the group of anionic, cationic, non-ionic, semi-polar and zwitterionic surfactants.

The optionally comprised surfactant is preferably comprised at a maximum of 10 wt.-% of all surfactants contained in the total composition.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), polyglycerol esters, glaycerol esters, propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

Non-limiting examples of zwitterionic surfactants include betaine, alkyldimethylbetaine, sulfobetaine, and combinations thereof.

The composition according to the instant invention can further comprise one or more auxiliary agents selected from the group consisting of bleaching systems, hydrotropes, polymers, anti-redeposition aids, sequestrants, water softeners, fiber protection agents, soil release agents, dye transfer inhibitors, fabric hueing agents, malodour removal additives, blueing dyes, preservatives systems, enzyme stabilizing agents like boric acid, probiotics, solvents, viscosity modifiers, pH-regulators and salts like NaCl and Na₂SO₄.

The composition as contemplated herein preferably is a detergent composition. It may be in any convenient form, e.g., a bar, a homogenous tablet, a tablet having two or more layers, a pouch having one or more compartments, a regular or compact powder, a granule, a paste, a gel, or a regular, compact or concentrated liquid. There are a number of detergent formulation forms such as layers (same or different phases), pouches, as well as forms for machine dosing unit.

Pouches can be configured as single or multicompartments. It can be of any form, shape and material which is suitable for hold the composition, e.g. without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxyprpyl methyl cellulose (HPMC).

Preferably the level of polymer in the film for example PVA is at least about 60%. Preferred average molecular weight will typically be from about 20,000 to about 150,000. Films can also be of blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticisers like glycerol, ethylene glycerol, Propylene glycol, sorbitol and mixtures thereof. The pouches can comprise a solid laundry detergent composition or part components and/or a liquid cleaning composition or part components separated by the water-soluble film. The compartment for liquid components can be different in composition than compartments containing solids, see for example US20090011970.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

The detergent composition according to the instant invention can be in form of a solid bar and used for hand washing laundry, hard surface cleaning, fabrics and/or textiles. The term bar includes laundry bars, soap bars, combo bars, syndet bars, cleaning tablets, cleaning bar and detergent bars. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The detergent composition according to the instant invention can be formulated as a granular detergent as described in for example WO09/092699, EP1705241, EP1382668, WO07/001262, U.S. Pat. No. 6,472,364, WO04/074419 or WO09/102854.

The instant invention further provides a process for cleaning a surface of an article, preferably a hard surface article, skin or hair, the hard surface preferably selected from glass, ceramics, plastics, tiles, linoleum, dishes and metal, comprising the steps of a) providing a composition according to the instant invention and an article, b) combining the provided composition and the provided article with water, c) maintaining the temperature of the water comprising the provided composition and the provided article in a temperature range of from 4° C. to 100° C., preferably from 10° C. to 65° C., more preferably from 15° C. to 45° C., d) separating the article from the water, and optionally e) rinsing the article with further water.

A preferred process according to the instant invention is characterized in that in step b) per kg of water 0.1 g to 50 g, preferably 1.0 g to 20 g, more preferably 2.0 g to 10 g, composition according to the instant invention are provided.

The instant invention further provides the use of a composition according to the instant invention for cleaning a surface of an article, preferably selected from hard surface articles, skin and hair, the hard surface preferably being selected from glass, ceramics, plastics, tiles, linoleum, dishes and metal.

Preferably the use according to the instant invention is characterized in that the surface of the article is cleaned from fat and/or oil containing stains with the article preferably being ceramic crockery.

The invention further provides for the use of the inventive composition for foam stabilization.

The invention further provides for the use of the composition according to the invention for improving the run-off behaviour of water from a hard surface, particularly of a surface selected from ceramics, glass and plastic.

The invention further provides for the use of the composition according to the invention for improving the drying behaviour of a hard surface, particularly of a surface selected from ceramics, glass and plastic.

The invention further provides for the use of the composition according to the invention for preventing limescale spots, particularly on ceramics, glass and/or plastic.

Components A) and B) and combinations thereof preferably used in the process and uses according to the instant invention are those which were mentioned above as preferred present in the compositions according to the invention.

The examples adduced hereinafter describe the present invention by way of example, without any intention that the invention, the scope of application of which is apparent from the entirety of the description and the claims, be restricted to the embodiments specified in the examples.

### BRIEF DESCRIPTION OF THE FIGURES

FIG. 1: Cleaning performance results for tested composition not according to the invention.

FIG. 2: Cleaning performance results for tested composition according to the invention.

### EXAMPLES

Rhamnolipids were prepared as described in EP3023431.

The sophorolipid used is a sophorolipid REWOFERM SL ONE from Evonik, which has a lactone to acid ratio of 40:60.

Glucolipids were produced according to example 2 of WO2019154970 via fermentation.

### Example 1: Cleaning Performance of Hard Surface Cleaning Formulations

This example demonstrates synergistic effect of sophorolipids and rhamnolipids in delivering cleaning performance of hard surface cleaning formulations.

Exemplary formulations described in the Table below have been prepared according to the following protocol: Initially, a measured amount of water was introduced into a glass beaker of a suitable size. Subsequently, further constituents (except sodium hydroxide) were added at room temperature and under vigorous stirring. The ingredients were added in no specific or uniform sequence as the order of addition to the solution was not critical. Finally, any remaining amount of water was introduced to ensure desired concentration of ingredients. All ingredients were mixed using a magnetic stirrer and pH of the solution was adjusted to 7.5 by addition of sodium hydroxide. The mixture was then stirred for 5 minutes to ensure a homogenous solution. The exemplary compositions were easily pourable and stable at room temperature for an extended period of time.

According to the above-described method, three formulations were prepared:

Reference formulation 1, that contained rhamnolipids among other ingredients, and was subsequently used as a control formulation,

Reference formulation 2, that contained sophorolipids among other ingredients, and was subsequently used as a second control formulation,

Test formulation 1, that contained mixture of rhamnolipids and sophorolipids, among other ingredients, and served subsequently to visualize synergistic effect of rhamnolipids and sophorolipids

Compositions of Test formulation 1 and Reference formulations evaluated in cleaning performance tests:

| | Reference | Reference | Test |
|---|---|---|---|
| | formulation | formulation | formulation |
| | 1/% | 2/% | 1/% |
| Rhamnolipids | 3.0 | 0.0 | 0.5 |
| Sophorolipids | 0.0 | 3.0 | 2.5 |
| Citric Acid | 0.2 | 0.2 | 0.2 |
| Sodium Citrate | 1.0 | 1.0 | 1.0 |
| Sodium Carbonate | 0.6 | 0.6 | 0.6 |
| 2-Phenoxyethanol | 0.1 | 0.1 | 0.1 |
| Sodium hydroxide | to achieve | to achieve | to achieve |
| | pH 7.5 | pH 7.5 | pH 7.5 |
| Water | Add to 100 % | Add to 100 % | Add to 100 % |

Subsequently, cleaning performance of Test formulation 1 was evaluated against the two reference formulations described above. The procedure used for the evaluating the cleaning performance is described in the following test protocol:

Cleaning performance test was conducted according to the internal test methodology, which was adapted from the recommendation of German Cosmetic, Toiletry, Perfumery and Detergent Association (IKW): “IKW Recommendation for the Quality Assessment of the Product Performance of All-Purpose Cleaners 2014” (IKW Test Protocol). The principle of the test was to evaluate the cleaning power of tested formulations by assessing their efficacy in removal of stubborn soil deposited on melamine tiles. White, melamine tiles covered with black, stubborn soil composed of mixture of fat and carbon black (here called Test Monitors) were purchased from Center for Testmaterials B.V. (available under the name DM-40 Tile). To ensure high reproducibility of the results, all Test Monitors belonged to the same production batch and were conditioned prior to use for 24 hours at 20° C. inside a climatic chamber.

To evaluate cleaning performance of the prepared formulations, Test Monitors were placed in a TQC Sheen washability tester (model AB5000) and locked in a position. One Test Monitor was placed in the Washability Tester at the time, but it was ensured that for each of the cleaning formulations, the test was conducted at least once at each of the four tracks of the Washability Tester. Subsequently, dry, 9 cm by 4.5 cm sponges were first moistened with tap water, and water excess was wrung out from sponges. Thereafter, 10 g of the test solution was loaded onto the sponge and sponge was attached to the cleaning arm of the Washability Tester. Washability Tester was then actuated and controlled to provide 35 cleaning cycles (so 70 linear strokes) over the Test Monitor. The speed of the strokes for 20 cycles per minute and the test was performed at room temperature. After 35 cleaning cycles were completed, the Test Monitor was removed from the Sheen tester, rinsed with tap water, and allowed to dry. The test was repeated several times to provide 5 replicates for each tested composition.

The treated Test Monitors were visually evaluated by five panelists who were asked to rate the cleaning efficacy achieved by each of the compositions. Panellists ranked the cleaning efficacy on a scale from 0 to 10, with 0 representing no observed cleaning and 10 representing a complete removal of the stain. For comparative purposes, each of the panellists was provided with a new, soiled Test Monitor that represented no cleaning as well as with a fully cleaned Test Monitor that represented the score of 10. Additionally, the panellists were provided with the evaluation template according to IKW Test Protocol to enable more accurate assessment of cleanness. The scores were summed and averaged for each of the tested composition and the results are reported in the table below.

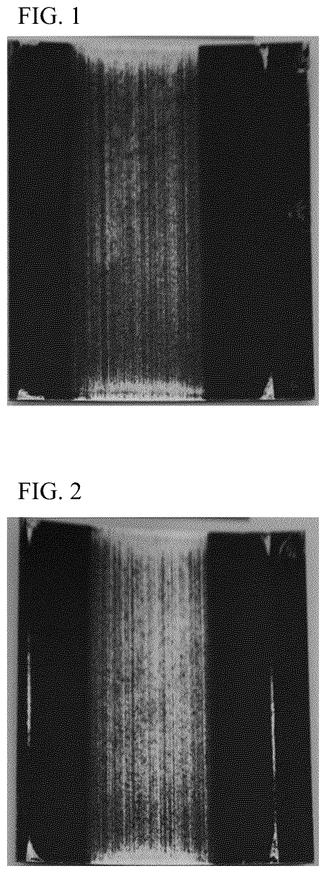

Cleaning performance results for tested compositions (average cleaning score, 0—no cleaning, 10—complete cleaning, and photographs of exemplary Test Monitors):

| | Reference | Reference | Test |
|---|---|---|---|
| | formulation 1 | formulation 2 | formulation 1 |
| Average | 4.8 | Not evaluated | 6.2 |
| cleaning score | | | |
| Image of an | see FIG. 1 | Test failed | see FIG. 2 |
| exemplary Test | | | |
| Monitor for | | | |
| the test series | | | |

As is readily evident from the results reported in the Table above, the composition containing mixture of rhamnolipids and sophorolipids delivers superior cleaning performance results to reference formulation 1. Moreover, it is worth mentioning, that Reference formulation 2 failed to perform in the above-mentioned test as the test sponges were not able to wipe horizontally over the surface of the test monitor, flipping and falling of the holder instead. Therefore, it became apparent that the addition of rhamnolipids to hard surface cleaner formulations containing sophorolipids is required to provide the sponge with sufficient ability to slip over dirty surfaces. Sophorolipids in turn provide cleaning formulation with apparent cleaning performance benefit when compared to the cleaning formulation containing rhamnolipids as sole surfactants. Therefore, the above-mentioned example provides a proof of the synergistic effect of rhamnolipids and sophorolipids when holistic properties of hard surface cleaning formulations are considered.

### Example 2: Cleaning Performance by Simple Compositions of Lipstick from Skin

The cleansing properties were determined by removing make-up from a simulated skin substrate such as VITRO-SKIN® (IMS) using a scrub abrasion and washability device. This method is designed to test the cleansing efficacy of aqueous surfactant solutions such as micellar waters or facial toners and can be used for make-up types that are able to dry completely on the described plates.

Procedure: A sheet of VITRO-SKIN® (3×11 cm) is placed in a desiccator (equipped with 295 g water and 52 g glycerin) for not more than 24 h. After hydration of the VITRO-SKIN® a defined weight of 4 mg lip stick (SUPER STAY 24H, Maybelline New York) is applied on the sheet The lip stick is dried for 1 h. The VITRO-SKIN® is fixed on a PMMA plate. The plate is fixed at the correct position, 2.5 g of the respective test solution, which are prepared by diluting each test substances with water to 3 wt %. Each one is applied onto a cotton pad and the cotton pad is attached to the sponge of the sliding carriage. After positioning of the sliding carriage, the removal experiment starts. The cycles are being set, whereas 1 cycle equals 1 movement forth and back. Speed: 10 cycles per minute, 1 cycle covers 160 mm. The cycles to remove all of the lip stick are counted, the results can be seen in table 4.

### Preparation of Test Solution

All test substances of table 3 were diluted with water to a 3 wt % solution and adjusted to a pH of 7.

TABLE 3
The following compositions were prepared:

| | Reference | Reference | Test |
|---|---|---|---|
| | formulation | formulation | formulation |
| | 3/% | 4/% | 2/% |
| Rhamnolipids | 3.0 | 0.0 | 1.0 |
| Sophorolipids | 0.0 | 3.0 | 2.0 |
| Citric Acid | to achieve | to achieve | to achieve |
| | pH 6.0 | pH 6.0 | pH 6.0 |
| Water | Add to 100 % | Add to 100 % | Add to 100 % |

TABLE 4
The following results were obtained

| | Reference | Reference | Test |
|---|---|---|---|
| | formulation 3 | formulation 4 | formulation 2 |
| Average amount | 109 | 117 | 77 |
| of wipes until | | | |
| visually clean | | | |

As can be seen right away, a synergistical effect is achieved for the combination of both biosurfactants.

1. A composition, comprising:
A) at least one sophorolipid and
B) at least one compound selected from the group consisting of rhamnolipids and glucolipids,
wherein a weight ratio of the at least one sophorolipid to all rhamnolipids and glucolipids comprised in the composition is in a range of from 2:1 to 500:11.

2. The composition according to claim 1, wherein component B) is selected from rhamnolipids.

3. The composition according to claim 1, wherein component B) comprises
51% by weight to 100% by weight of mono-rhamnolipids,
where percentages by weight refer to a sum of all of the rhamnolipids present.

4. The composition according to claim 1, wherein the composition comprises component A) at a concentration of from 0.5% by weight to 40% by weight, the percentages by weight referring to a total composition.

5. The composition according to claim 1, wherein the composition comprises component B) at a concentration of from 0.25% by weight to 20% by weight, the percentages by weight referring to the total composition.

6. The composition according to claim 1, wherein the composition comprises component A) and component B) in total at a concentration 0.8% by weight to 45% by weight, wherein the percentages by weight refer to the total composition.

7. The composition according to claim 1, wherein a pH of the composition at 25° C. is from 2.0 to 12.0.

8. A process for cleaning a surface of an article, the process comprising:
a) providing a composition according claim 1 and an article,
b) combining the provided composition and the provided article with water,
c) maintaining a temperature of the water comprising the provided composition and the provided article in a temperature range of from 4° C. to 100° C.,
d) separating the article from the water, and optionally
e) rinsing the article with further water.

9. A The process according to claim 8, comprising:
providing in b) per kg of water 0.1 g to 50 g of the composition.

10. A process, comprising:
cleaning a surface of an article with the composition according to claim 1.

11. The process Use according to claim 10, comprising:
cleaning the surface of the article from fat and/or oil containing stains.

12. A process, comprising:
stabilizing a foam with the composition according to claim 1.

13. A process, comprising: improving run-off behaviour of water from a hard surface with the composition according to claim 1.

14. A process, comprising:
improving drying behaviour of a hard surface with the composition according to claim 1.
